(19) United States
(12) Patent Application Publication
(10) Pub. No.: US 2010/0097800 A1
(43) Pub. Date: Apr. 22, 2010

(54) led-based lighting method & a lighting fixture

(76) Inventor: Jie OU YANG, Xiamen (CN)

Correspondence Address: Dr. BANGER SHIA;Patent Office of Bang Shia, 102 Lindencrest Ct., Sugar Land, TX, 77479-5201, US

(21) Appl. No.: 12/530,133

(22) PCT Filed: Aug. 27, 2007
(86) PCT No.: PCT/CN2007/002579

§ 371 Date: Sep. 4, 2009

(30) Foreign Application Priority Data
Mar. 6, 2007 (CN) 200720005613.X

(51) Int. Cl. F21V 1/00

(52) U.S. Cl. 362/235

(57) ABSTRACT

An LED based lighting method and a lighting fixture thereof includes multiple LEDs mounted on an LED lamp stand and arranged in array; a convex lens is disposed to a front of each LED; depending on the quantity of LEDs, the area to be illuminated is classified into multiples illuminated units with each corresponding to one LED; convex lenses of different focusing angles of beam of light are selected in case of a fixed focal length or the focal length of each lens device is adjusted so to select or regulate for a proper LED illuminating angle; no dark area exists and the brightness of the area illuminated is very consistent since the spot created by the LED illuminating beam of light after focusing by the convex lens over the area to be illuminated merely covers its corresponding illuminated unit; all the LEDs are mounted on the LED lamp stand properly spaced at intervals and a housing of each LED is totally exposed in the air to skip heat radiation device for lowering production cost, and making the LED streetlamp smaller and lighter, and easier installation and service.

### BACKGROUND OF THE INVENTION

(a) Field of the Invention

The present invention is related to a lighting method and a lighting fixture (thereof), and more particularly, to one that has LED as light source.

(b) Description of the Prior Art

Conventional streetlamp, e.g., a high voltage mercury lamp relies upon externally provided reflection device, e.g., a reflective cup or a lampshade resulting in a waste of light source as high as 40-60%. On the contrary, a light emitting diode (LED) light source directly emits 80-90% of its luminance on a target object. Therefore, given with the same lumen, the LED light source performs much better than any other conventional light source. At present, LED lighting has become the mainstream in the era demanding green lighting and energy saving and is essentially applied in products including streetlamps, decorative lighting, night scene projects.

As encouraged by those advantages provided by LED, manufacturers in the trade start to develop LED streetlamp one after another. For being subject to LED power limitation (generally, 30˜40 lumens), plate LED lamp stands are commonly adapted to the existing LED streetlamps so to make light streams emitted by multiple LEDs to overlap one another for enhancing brightness. Their illumination indicates a circular form on the ground. Whereas LED has a smaller illumination angle, the illumination radius of the LED streetlamps is smaller. If the streetlamp stands 5.5 m tall, the radius of its illuminating area is 12 m only; the central brightness is 40 LUX or higher; and the peripheral brightness is 3 LUX only; meaning the highest brightness is found at the central position of the illumination while it is darker at the peripheral of the illuminating area. Should the streetlamps be erected higher (e.g., 12 m tall on freeway) and spaced at greater intervals (30 m on freeway), the mid area between two streetlamps would be completely dark and fail to meet national standard. As all LEDs are mounted on the plate shaped lamp stand, the LED streetlamp suffers a smaller illumination angle and smaller coverage of illumination for being limited to the illumination angle of the LED. It therefore takes additional LED streetlamps of higher power or narrow down the space among streetlamps to correct these problems of lower brightness and smaller coverage of illumination. As a result, higher cost is unavoidable. Furthermore, higher power means great demand of heat radiation. Common problems of large volume and heavy weight exist in the LED streetlamp resulting in higher installation and construction costs makes it is very difficult to promote the use of LED streetlamp.

As illustrated in FIG. 1 of the accompanying drawings, CREE website from USA discloses an LED streetlamp 6′, which is comprised of six up to eight units of LED distributed on two wings 4′ and 5′ of a V shaped lamp stand; two naked LED units 1a′ and 1b′ disposed at a center of the lamp stand vertically illuminate on a road while the other units 2a′, 2b′, 3a′, and 3b′ are respectively mounted on both wings 4′ and 5′ of the V shaped lamp stand at different angles and each is provided with a shade of convex lens so to enlarge the illumination scope. Whereas each unit of LED from the streetlamp 6′ remains an installation of plate, most of light streams emitted will be eventually converged. For example, each LED on the naked unit of LED 1a′ emits its light vertically onto the road. To avoid light streams from being converged, wider distance among LEDs must be provided; and in turn, the volume of the entire streetlamp 6′ is enlarged. Meanwhile, the cost is increased since the structure of the streetlamp 6′ becomes even more complicated when those LEDs must be each provided with the shade of convex lens at an angle different from one another. Furthermore, the LED streetlamp 6′ suffers poor adaptability because that each shade of convex lens is fixed in position unable to re-adjust changes by the height of the LED streetlamp, brightness of the LED, and conditions of the road.

### SUMMARY OF THE INVENTION

The primary purpose of the present invention is to provide an LED based lighting method and a lighting fixture that delivers wider coverage of illumination and comparatively consistent brightness without relying upon heat radiation device.

Another purpose of the present invention is to provide an LED based lighting method and a lighting fixture that allows readjustment changes by the height of the LED streetlamp, brightness of the LED, and conditions of the road.

To achieve these purposes, an LED based lighting method of the present invention is comprised of the following steps:

(1) Multiple LEDs are mounted on a lamp stand of an LED fixation plate and arranged in array;

(2) Each LED is disposed at its front with a lens device;

(3) The area to be illuminated is divided into multiple illuminated units in a number equal to that of those LEDs provided, and each LED corresponds to one illuminated unit; and

(4) A spot created by LED illumination merely covers up its corresponding illuminated unit through proper focusing of the lens device and selection of a proper LED illumination angle.

The lens device is related to a convex lens zooming device; and the LED is located at where between zero focal length and two time of focal length by adjusting a distance between the lens device and the LED thus for the illuminating spot of the LED to merely cover up its corresponding illuminated unit.

The adjustable distance for the LED and the lens device is realized by means of a telescoped structure.

Whereas the focal length of the lens device is not adjustable, convex lenses provided with different focusing angles of the light beam are selected for the illuminating spot of LED to merely cover up its corresponding illuminated unit.

The convex lens is related to a total reflection mono-convex lens or a biconvex lens.

The proper LED illumination angle is related to that those LED are arranged in array with the LED located at the center of the array illuminates downward and vertically to the ground; the remaining LEDs disposed on both sides are in sequence either outwardly arranged in radius or inwardly in convergence in symmetry and to the central LED; and the included angle defined by each LED and the central LED gradually and outwardly becomes greater. Should all LEDs other than the central one be distributed in symmetry to the central LED in radius, the relation between the illumination length, X, of each LED and the included angle a is described in a formula of X=(N−M)/sin a; wherein N is the range between a center of an illuminated unit that a certain LED corresponds to and the center of the illuminated unit that the central LED corresponds to; and M, the distance between that LED and the central LED. The included angle a is solved by operating the formula and the illumination angle of the LED is determined accordingly. If all the LEDs are in sequence arranged in symmetry against the central LED and in a fashion of inwardly convergence, the relation between the illumination length L of each LED and the included angle a is expressed in a formula: L=(y+y1)/sin a; wherein, y is the range between a center of an illuminated unit that a certain LED corresponds to and a center of the illuminated unit that the central LED corresponds to; and y1, the distance between that LED and the central LED. Again, the included angle a is solved by operating the formula and the illumination angle of the LED is determined accordingly.

The illumination angle of the LED may be fixed or adjustable.

A lighting fixture using the LED based lighting method is comprised of a lid, multiple LEDs, and an LED stand. The LED stand is disposed in the lid and those LEDs disposed thereon are arranged in array. A lens device is disposed to a front of the LED; a central LED on the LED stand illuminates downward and vertically to the ground; LEDs on both sides are in sequence arranged either in radius outwardly or in convergence inwardly in symmetry. Should all LEDs other than the central one be distributed in symmetry to the central LED in radius, the relation between the illumination length, X, of each LED and the included angle a is described in a formula of X=(N−M)/sin a; wherein N is the range between a center of an illuminated unit that a certain LED corresponds to and the center of the illuminated unit that the central LED corresponds to; and M, the distance between that LED and the central LED. The included angle a is solved by operating the formula and the illumination angle of the LED is determined accordingly. If all the LEDs in sequence are arranged inwardly in convergence and in symmetry to the central LED; the relation between the illumination length L of each LED and the included angle a is expressed in a formula: L=(y+y1)/sin a; wherein, y is the range between a center of an illuminated unit that a certain LED corresponds to and the center of the illuminated unit that the central LED corresponds to; and y1, the distance between that LED and the central LED. Again, the included angle a is solved by operating the formula and the illumination angle of the LED is determined accordingly.

The lens device is related to a convex lens zooming device; and the LED is located at where between zero focal length and two time of focal for the illuminating spot of the LED to merely cover up its corresponding illuminated unit.

The LED is made in a cylindrical form and contained in a tube while the convex lens is mounted in another tube at where in front of the LED. Both tubes are inserted to each other and allow travel by sliding for adjusting the distance between the LED and the convex lens for the LED to be located at where between zero focal length and two time of focal length of the convex lens.

The focal length of the lens device is not adjustable, and a lens of different light beam focusing angle is selected for the illuminating spot of the LED to merely cover up its corresponding illuminated unit.

The lens is related to a total reflection, mono-convex or a biconvex lens.

The LED stand may be made in a plate or an arc form.

The LED stand is comprised of multiple jigsaw pieces with each piece disposed with protruding and recessed edges to be abutted to other jigsaw pieces and further provided with at least one mounting hole to secure the LED. The surface of each piece may be made in flat or in an arc form.

The lighting fixture includes an LED stand and multiple cylindrical LEDs. The LED stand is comprised of multiple secondary beams and two primary beams. Each secondary beam is related to a long and narrow strip with both ends respectively disposed with a protruding piece to lock the secondary beam to the primary beam, and a mounting hole to secure the cylindrical LED in place. The mounting hole disposed on the central LED permits the central LED made in a cylindrical form to illuminate downwardly and vertically to the ground. The inner side of the mounting hole is made an inclination that is different from that of another mounting hole so that those LEDs to be arranged in sequence and in symmetry either in radius outwardly or in convergence inwardly from or to the central LED. The primary beam is disposed with locking hole to fit the protruding piece of the secondary beam. Each locking hole is made an angle from that of another locking hole so that those secondary beams on both sides are arranged with a central secondary beam as a center in sequence and in symmetry either in radius outwardly or in convergence inwardly from or to the central secondary beam. Each cylindrical LED is fixed to the secondary beam.

The cylindrical LED is related to an LED flashlight.

The cylindrical LED may be fixed in place or movably mounted with angle adjustable to the LED stand.

An LED series circuit is related to a bypass circuit.

DC voltage of the LED is related to a pulsation with a working cycle no less than 50 Hz and its strobe is invisible to human eyes.

The lid is disposed with a light permeable lampshade.

A lens is disposed on the lampshade at where in front of each LED and in a direction vertical to the LED beam of light.

Multiple air inlets are disposed at a lower end on one side of the lid; multiple air outlets are disposed on an upper end on the other side of the lid; and two filtration hoods are respectively disposed over the air inlets and the air outlets.

Accordingly, LEDs of the present invention are arranged in array on the LED stand. If the quantity of the LEDs provided in the present invention is N, the quantity of the illuminated units assigned corresponding to the area to be illuminated is also N. An adjustable lens device is disposed in front of each LED.

Though adjusting the distance between the lens device and the LED and illumination angle, the spot created by the LED over the area to be illuminated merely covers up the corresponding illuminated unit.

Whereas the spot becomes light convergence, instead of light diffusion of the LED, the brightness is comparatively consistent. Controlling the size of the spot through adjusting the lens device, the spot allows connection or overlapping of peripherals. The fact that each corresponding illuminated unit on the area to be illuminated is covered up by the spot created by the LED eliminates any dark area of illumination, resulting in that the brightness in the entire area illuminated is very consistent.

### BRIEF DESCRIPTION OF THE DRAWINGS

FIG. 1 is a schematic view showing a V shaped LED streetlamp and an illuminated road disclosed by CREE, USA.

FIG. 2 is a schematic view showing a road illuminated by the present invention.

FIG. 3 is a schematic view showing a cylindrical construction of the present invention.

FIG. 4 is a schematic view showing an operating status of adjusting a distance between the LED and a lens device of the cylindrical LED of the present invention.

FIG. 5 is a schematic view showing a construction of multiple cylindrical LEDs of the present invention are outwardly arranged in radius.

FIG. 6 is a schematic view showing a construction of multiple cylindrical LEDs of the present invention are inwardly arranged in convergence.

FIG. 7 is a schematic view showing an optical route of multiple LEDs outwardly arranged in radius of a lighting fixture of the present invention.

FIG. 8 is a schematic view showing a relation between LED illumination angle and illumination distance of multiple LEDs outwardly arranged in radius of the lighting fixture of the present invention.

FIG. 9 is a schematic view showing a construction of another preferred embodiment of the present invention wherein multiple cylindrical LEDs are outwardly arranged in radius.

FIG. 10 is a schematic view showing an optical route of multiple LEDs inwardly arranged in convergence of a lighting fixture of the present invention.

FIG. 11 is a schematic view showing a relation between LED illumination angle and illumination distance of multiple LEDs inwardly arranged in convergence of the lighting fixture of the present invention.

FIG. 12 is a schematic view showing an optical route of multiple cylindrical LEDs inwardly arranged in convergence of the present invention.

FIG. 13 is an exploded view showing a construction of the lighting fixture of the present invention.

FIG. 14 is a schematic view showing an assembly of the lighting fixture of the present invention taken from FIG. 13.

FIG. 15 is a schematic view showing a construction of another preferred embodiment of the present invention wherein multiple L shaped cylindrical LEDs are outwardly arranged in radius.

FIG. 16 is a schematic view showing a construction of an LED stand comprised of multiple jigsaw pieces of the lighting fixture of the present invention.

FIG. 17 is a schematic view showing a construction of an LED stand comprised of multiple jigsaw pieces in a third preferred embodiment of the lighting fixture of the present invention.

FIG. 18 is a schematic view showing a construction of a sixth preferred embodiment of the present invention.

FIG. 19 is schematic view showing a construction of a fixation stand of a primary beam and a secondary beam of the lighting fixture in the sixth preferred embodiment of the present invention.

FIG. 20 is schematic view showing an assembly of multiple cylindrical LEDs and the primary beam and the secondary beam of the lighting fixture in the sixth preferred embodiment of the present invention.

FIG. 21 is a wiring drawing of a bypass circuit applied in the lighting fixture of the present invention.

FIG. 22 is an exploded view showing a light figure of an eighth preferred embodiment of the present invention.

FIG. 23 is a perspective view showing a lampshade of the lighting fixture in the eighth preferred embodiment of the present invention.

FIG. 24 is a perspective view showing a lid of a lighting fixture in a ninth preferred embodiment of the present invention.

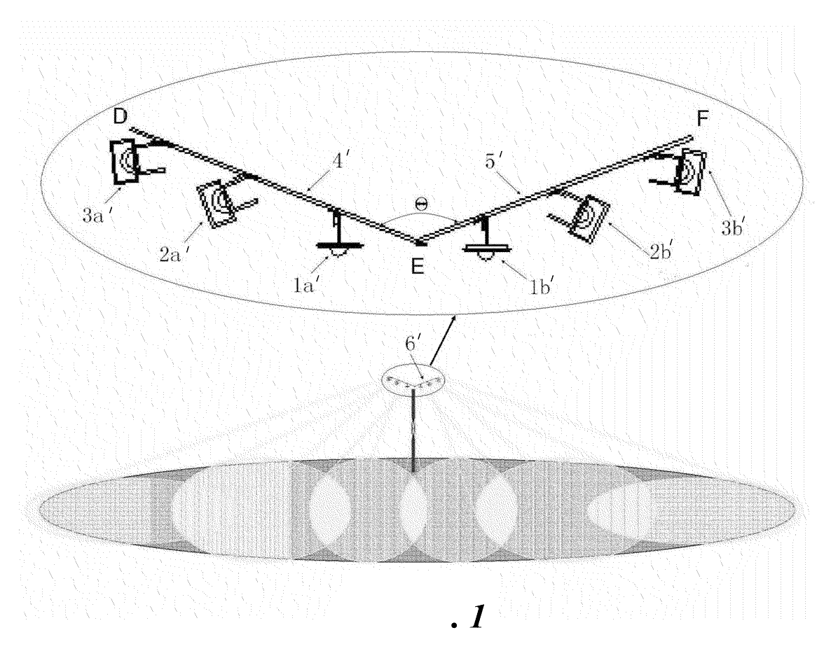

### DETAILED DESCRIPTION OF THE PREFERRED EMBODIMENTS

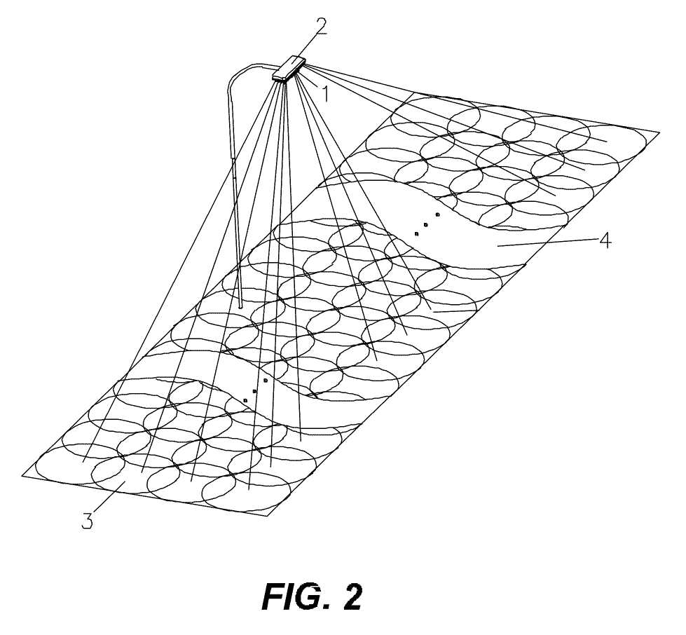

Referring to FIG. 2, an LED based lighting method is comprised of the following steps:

(1) Multiple LEDs 1 are mounted on a lamp stand 2 and arranged in array;

(2) Each LED 1 is disposed at its front with a lens device (not illustrated);

(3) An area 4 to be illuminated is divided into multiple illuminated units 3 in a number equal to that of those LEDs provided, and each LED 1 corresponds to one illuminated unit 3; and

(4) A spot created by LED illumination merely covers up its corresponding illuminated unit 3 through proper focusing of the lens device and selection of a proper LED 1 illumination angle.

The lens device is related to a convex lens zooming device; and the LED 1 is located at where between zero focal length and two time of focal length by adjusting a distance between the lens device and the LED 1 thus for the illuminating spot of the LED 1 to merely cover up its corresponding illuminated unit 3. The adjustable distance for the LED 1 and the lens device is realized by means of a telescoped structure.

When the focal length of the lens device is not adjustable, convex lenses provided with different focusing angles of the light beam are selected for the illuminating spot of LED 1 to merely cover up its corresponding illuminated unit 3. The convex lens is related to a total reflection mono-convex lens or a biconvex lens.

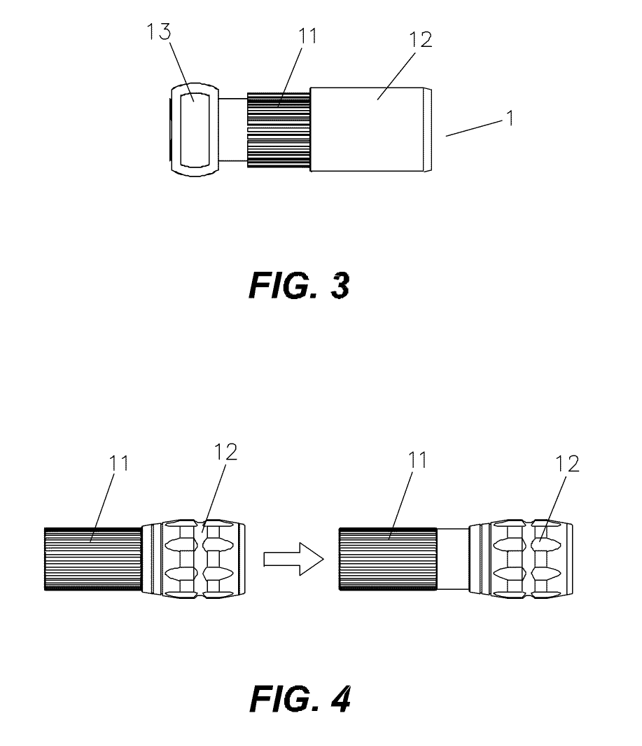

Now referring to FIGS. 3 and 4, a cylindrical LED is comprised of a tube 11, the LED, a convex lens, and another tube 12. The LED is disposed in the tube 11; the convex lens is provided in the tube 12 and in front of LED (not illustrated); both tubes 11 and 12 are inserted to each other and relatively travel by sliding for adjusting the distance between the LED and the convex lens so that the LED is located at where between zero focal length and two time of focal length of the convex lens. As the distance between both tubes 11 and 12 increases, the spot of the LED created on the illuminated area becomes smaller; and decreases, larger. The cylindrical LED may be related to an LED zooming flashlight.

Illumination angle of each LED 1 satisfies the following conditions:

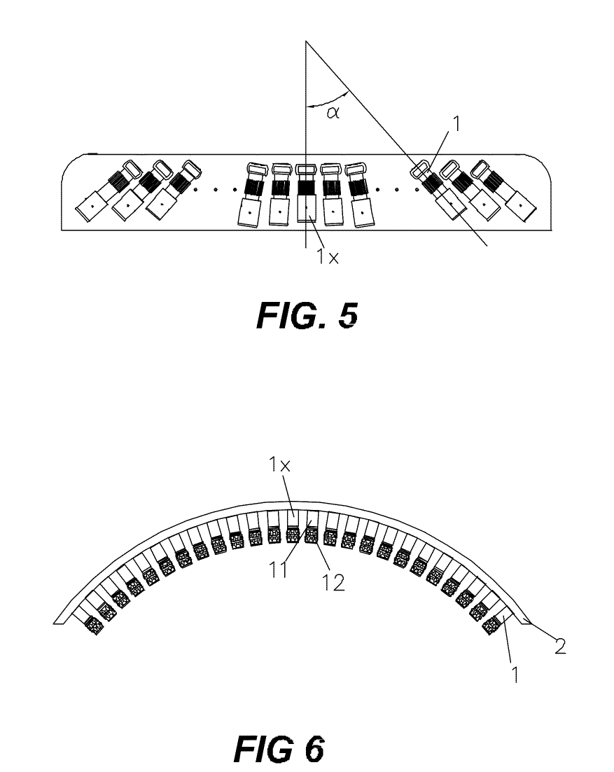

(1) As illustrated in FIGS. 5 and 6, a central LED 1X of those LEDs disposed on the LED stand 2 illuminates downwardly and vertically to the illuminated area; with the central LED 1X as a center, the remaining LEDs 1 are in sequence arranged outwardly in radius or inwardly in convergence and in symmetry; and an included angle a defined by LED 1 and the central LED 1X gradually becomes larger from the center to both ends of the LED stand.

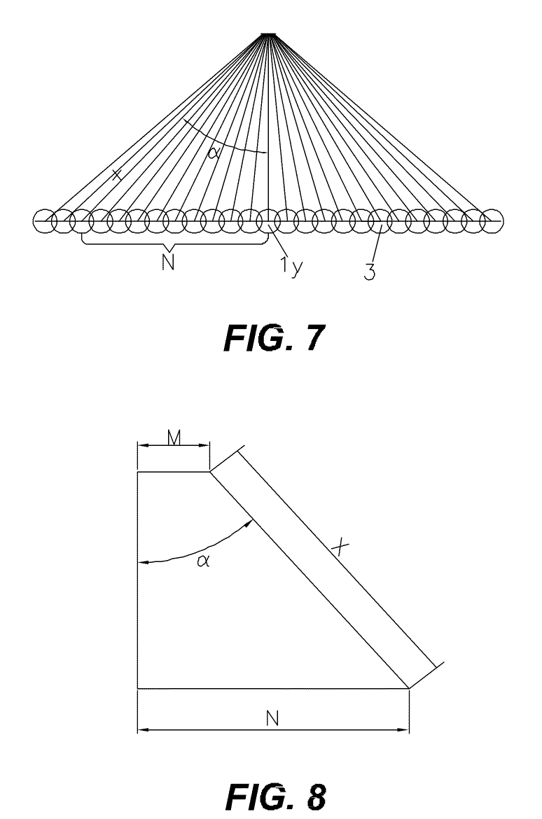

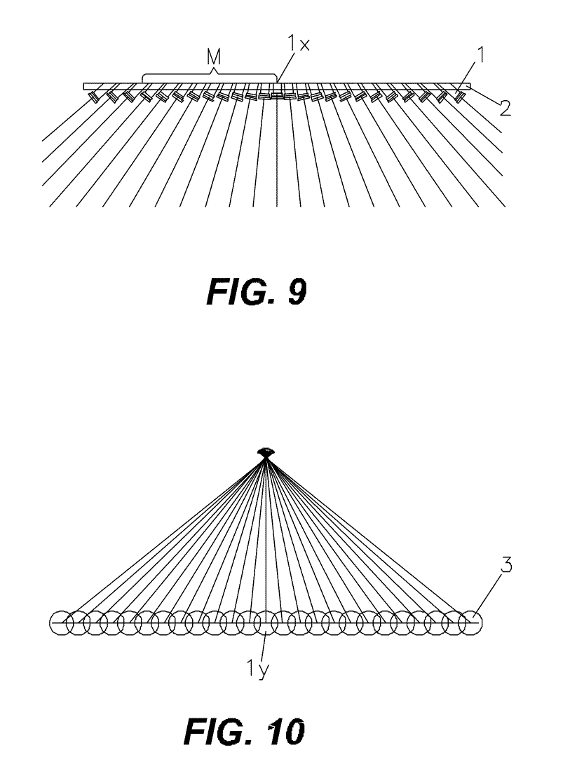

(2) When those LEDs 1 are in sequence arranged outwardly in radius and in symmetry to the central LED 1X in as illustrated in FIGS. 7, 8, and 9, the relation between each LED 1 illumination length and the included angle a is expressed in a formula of: illumination length X=(N−M)/sin a, wherein N is the distance between a center of an illumination unit 3 that a certain LED 1 corresponds to and the distance between a center 1Y of the illumination unit 3 that the central LED 1 corresponds to; and the illumination angle of the LED 1 is determined by solving the included angle a through the operation of the formula.

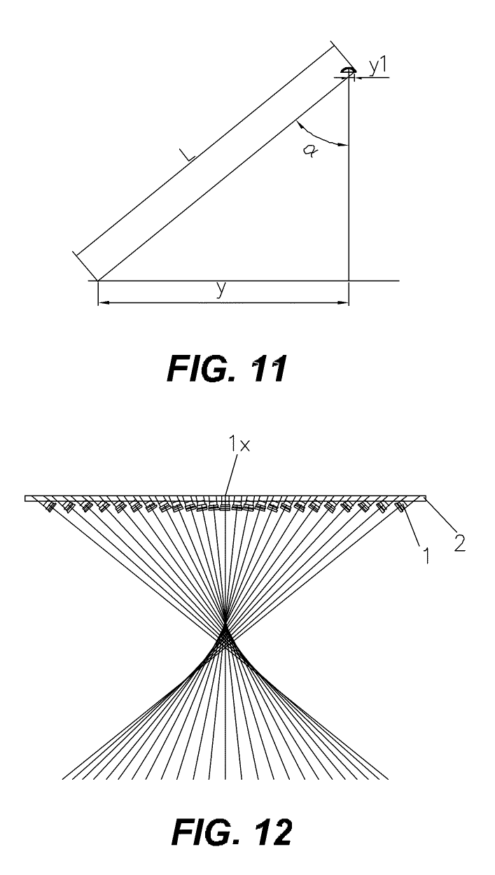

(3) When those LEDs 1 are in sequence inwardly arranged in convergence and in symmetry to the central LED 1X in as illustrated in FIGS. 10, 11, and 12, an optical route of the LED indicates a sandglass shape, i.e., light streams are converged and then diffused through the convex lens device to form a spot; and the relation between the illumination length L and the included angle a for each LED 1 is expressed in a formula of: illumination length L=(y+y1)/sin a, wherein y is the distance between a center of the illumination unit 3 that a certain LED 1 corresponds to, and a center 1Y of the illumination unit 3 that the central LED 1X corresponds to; and y1, the distance between the LED 1 and the central LED 1X. The illumination angle of the LED 1 is determined by solving the included angle a through the operation of the formula.

Accordingly, the key point of the design of the LED based lighting method of the prevent invention rests on that if the quantity, N, of multiple LEDs 1 are provided in the present invention, the quantity of illumination units 3 classified in the area 4 is also the same N; the lens device is disposed in front of each LED 1; by adjusting the focal length of each lens device or in case of a fixed focal length, lenses of different focusing angle of beam of light are selected, and by adjusting or selecting a proper illumination angle of the LED 1, the beam of light illuminated by the LED 1 after focusing by the lens forms a spot on the illuminated area 4 to merely cover up its corresponding illumination unit 3. The LED stand 2 in the present invention may be made in a plate or an arc form; and the LED 1 may be fixed at a given angle, or the LED 1 may be movably mounted with its angle adjustable as long as the illumination angle of the LED 1 meets those conditions described above.

Whereas the spot is related to a convergent light, instead of diffusion light of the LED 1, the brightness is comparatively consistent. By controlling the size of the spot through adjusting the lens zooming device or selecting a lens with a proper focusing angle of beam of light, the spot may be connected or overlapped at the peripheral of another spot. Therefore, dark area is eliminated by adjusting and selecting a proper illumination angle of the LED 1, each illumination unit 3 on the area 4 to be illuminated 4 is covered by the sport created by its corresponding LED 1.

Taking the lighting on a freeway for example, all the streetlamps are erected at a given interval of 30 m between two streetlamps, and the height of each streetlamp is 12 m; a rectangular area of 15 m×6 m is assigned for illumination by each streetlamp; and 100 units of LEDs with each in specification of 1 W and 80 lumens are arranged in four lines with its longer side in consistent with the longitudinal direction of the freeway; and a 1.2 m or longer spot is created by the LED on the freeway by adjusting the distance between the convex lens device and the LED. Accordingly, when all spots are arranged in a group, a section of the freeway in a length of 30 m is completely illuminated with the brightness of the spot created at the farthest end being not less 10 LUX; and that at a central spot, not less than 20 LUX to meet the standard requirements that the brightness respectively at the edge and the center shall not be less than 1:2 or 1:3.

Nine preferred embodiments of LED lighting fixture used in the lighting method as described above are provided as follows.

In a first preferred embodiment, a central LED 1x (1X) on an LED stand 2 illuminates downward and vertically to the ground; with the central LED 1X as a center, all LEDs 1 are in sequence inwardly arranged in convergence and in symmetry to the central LED 1X.

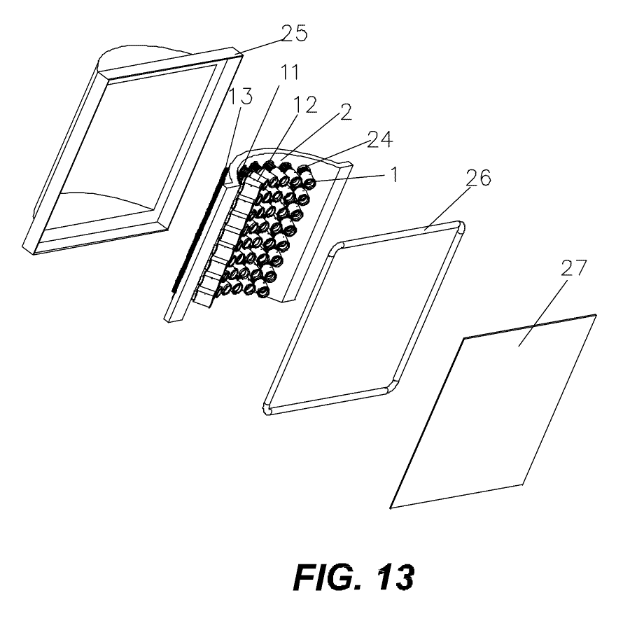

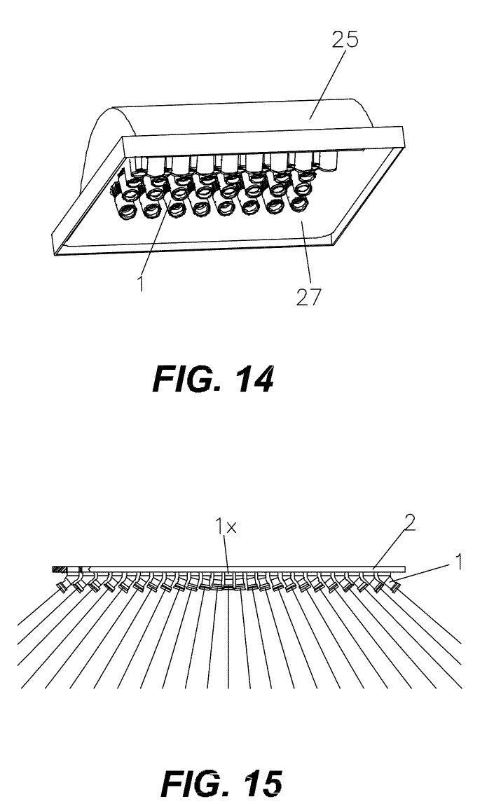

As illustrated in FIGS. 13 and 14, an LED lighting fixture of the present invention is comprised of an LED stand 2 and multiple cylindrical LEDs 1 arranged in array. Wherein, the cylindrical LED 1 includes a tube 11, an LED, a convex lens, and another tube 12. The LED is disposed in the tube 11; the convex lens is disposed in the tube 12; the convex lens (not illustrate) is located in front of the LED, both of the tubes 11 and 12 are inserted to each other and relatively travel by sliding to adjust the distance between the LED and the convex lens so that the LED is located at where between zero focal length and two time of focal length of the convex lens. As the distance between both tubes 11 and 12 increases, the spot created by the LED on the illuminated are becomes smaller; and decreases, larger. The LED stand 2 is made in an arc form and multiple mounting holes 24 are provided thereon; a tail 13 of the cylindrical LED 1 is inserted through those mounting holes 24 thus to be secured on the LED stand 2. The LED stand 2 is provided in the lid 25, and a light permeable lampshade 27 is mounted to a front of the lid 25 with a square sealing ring 26 disposed in the middle.

As illustrated in FIG. 6 or 12, 25 cylindrical LEDs 1 arranged in different angles among one another are disposed on the LED stand 2. The LED stand 2 as illustrated in FIG. 6 is made in an arc form and the cylindrical LED 1 is vertically secured to the LED stand 2; and the LED stand 2 as illustrated in FIG. 12 is made in a plate form as long as the illumination angle of the cylindrical LED 1 meets the following conditions: with the central LED 1X as the center, all cylindrical LEDs 1 are in sequence inwardly arranged in convergence and in symmetry to the central LED 1X; an included angle a defined by each of those cylindrical LEDs 1 provided on both sides and the central LED 1X gradually becomes larger towards both ends. The relation between an illumination length of each cylindrical LED 1 and the included angle is expressed in a formula of: illumination length L=(y+y1)/sin a; wherein y is a distance between a center of the illumination unit 3 that a certain LED 1 corresponds to and a center 1Y of the illumination unit 3 that the central LED 1X corresponds to; and y1 is the distance between the LED 1 and the central LED 1X. The illumination angle of the LED 1 is determined by solving the included angle a through the operation of the formula.

If the lighting fixture is 12 m tall, the illumination length to the ground is 30 m, and the total included angle of each LED is 98.7°, data of the included angle defined by the central LED 1X and respective cylindrical LED 1, 2, 3, 4, etc., and illumination length to the ground by LED are listed below (only data of 13 LEDs out of 25 LEDs are listed since all 25 LEDs are arranged in symmetry):

| | Included | Illumination Length |
|---|---|---|
| No. | Angle (°) | to the Ground (M) |
| 1(Center) | 0 | 12 |
| 2 | 5.57 | 12.049 |
| 3 | 11.03 | 12.218 |
| 4 | 16.30 | 12.494 |
| 5 | 21.29 | 12.870 |
| 6 | 25.96 | 13.338 |
| 7 | 30.28 | 13.887 |
| 8 | 34.25 | 14.509 |
| 9 | 37.88 | 15.194 |
| 10 | 41.18 | 15.934 |
| 11 | 44.17 | 16.721 |
| 12 | 46.89 | 17.549 |
| 13 | 49.35 | 18.416 |

In a second preferred embodiment, a central LED 1X disposed on an LED stand 2 illuminates downward and vertically to the ground; with the central LED 1X as a center, all LEDs 1 in sequence are outwardly arranged in radius and in symmetry to the central LED 1X.

As illustrated in FIG. 15, 25 LEDs 1 each made in a form of L shaped cylinder and an illumination angle different among one another are disposed on an LED stand 2. The LED stand 2 is made in a plate form. The illumination angle of each L-shaped cylindrical LED 1 meets the following conditions: all L shaped cylindrical LEDs 1 with the central LED 1X as a center are in sequence arranged outwardly in radius and in symmetry to the central LED 1X; multiple included angles a respectively defined by each of those L shaped cylindrical LEDs 1 on both sides and the central LED 1X become greater by LED 1 towards both ends of the LED stand 2; and the relation between illumination length X of each L shaped cylindrical LED 1 and the included angle a is expressed in a formula of: illumination length X=(N−M)/sin a. Wherein, N is the distance between a center of the illumination unit 3 that a certain LED 1 corresponds to and the center of the illumination unit 3 that the central LED 1X corresponds to; and M, the distance between the LED 1 and the central LED 1X. The illumination angle of the LED 1 is determined by solving the included angle a through the operation of the formula.

When the light fixture is 12 m tall and the illumination length to the ground is 30 m, 25 LEDs are disposed with the central LED 1X assigned with a serials number of (LED)1 and other L shaped cylindrical LEDs 1 assigned in sequence outwardly serials numbers of 2, 3, 4 . . . 25; data of the included angle defined by the central LED 1X and respective L shaped cylindrical LED 1, 2, 3, 4, etc., and illumination length to the ground by LED are listed below (only data of 13 LEDs out of 25 LEDs are listed since all 25 LEDs are arranged in symmetry):

| | Included | Illumination Length |
|---|---|---|
| No. | Angle (°) | to the Ground (M) |
| 1 | 0 | 12.183 |
| 2 | 5.77 | 12.244 |
| 3 | 11.44 | 12.425 |
| 4 | 16.89 | 12.720 |
| 5 | 22.05 | 13.122 |
| 6 | 26.87 | 13.621 |
| 7 | 31.32 | 14.207 |
| 8 | 35.40 | 14.809 |
| 9 | 39.12 | 15.597 |
| 10 | 42.50 | 16.380 |
| 11 | 45.55 | 17.215 |
| 12 | 48.32 | 18.090 |
| 13 | 50.83 | 19.000 |

Whereas the brightness of a spot converged and created o the illuminated area by the LED 1 is consistent, saving energy is achieved by providing a drive circuit to control voltage and amperage applied to the LED 1 and by controlling the quantity of the LEDs 1 to be illuminated. Furthermore, further energy saving is achieved for the LED 1 lighting fixture by directly use of DC pulsation voltage. For example, the power consumption will be significantly reduced when the DC voltage applied on the LED 1 is related to a pulsation with a working cycle not less than 50 Hz of a strobe invisible to human eyes. In a constant current circuit, the LED 1 connected in series is related to a bypass circuit as illustrated in FIG. 21, meaning, even any LED connected in series is damaged, light emission by other LEDs will not be affected so to reduce the frequency of service work. The DC voltage applied on the LED 1 is related to a pulsation with a working cycle not less than 50 Hz of a strobe invisible to human eyes.

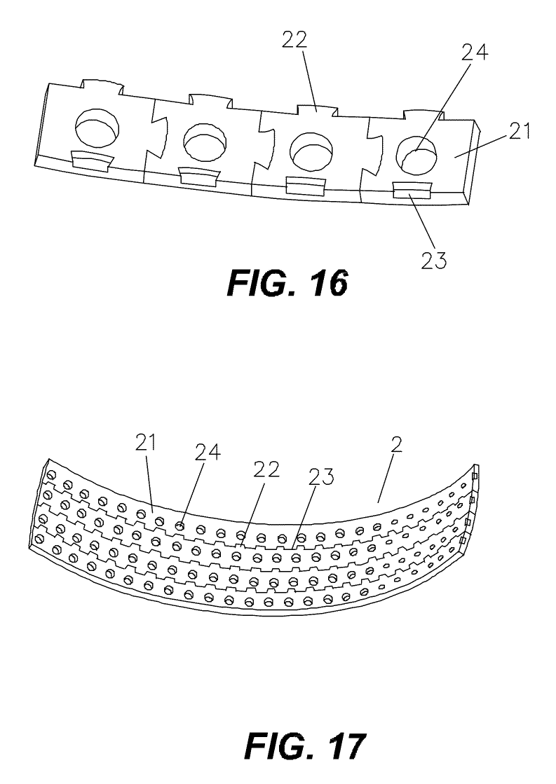

In a third preferred embodiment as illustrated in FIGS. 16 and 17, an LED stand 2 of the present invention is comprised of multiple jigsaw pieces 21 with each piece 21 provided with protruding edges 22 and recessed edges 23 to be abutted to other jigsaw pieces 21; at least one mounting hole 24 is disposed on each jigsaw piece 21; and a surface of the jigsaw piece 21 is made in a flat or an arc form.

In a fourth preferred embodiment, each jigsaw piece 21 is disposed with only a single mounting hole 24 as illustrated in FIG. 16 or disposed with multiple mounting holes 24 as illustrated in FIG. 17. In practical installation, the LED is fixed in the mounting hole 24 before connecting multiple jigsaw pieces together as required.

In a fifth preferred embodiment, the lens device is prevented from adjusting its focal length, then a lens of different focusing angle of beam of light is selected so that the spot created on the ground illuminated by the illuminating beam of light passing through the lens device merely to cover up the corresponding illumination unit 3. The lens is related to a total reflection mono-convex or biconvex lens.

Multiple cylindrical LEDs 1 are fixed on an LED stand 2 in a sixth preferred embodiment.

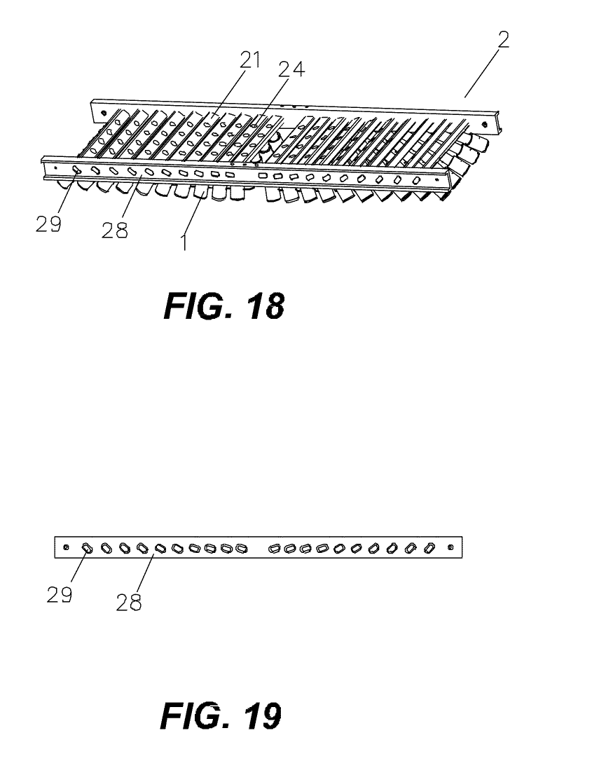

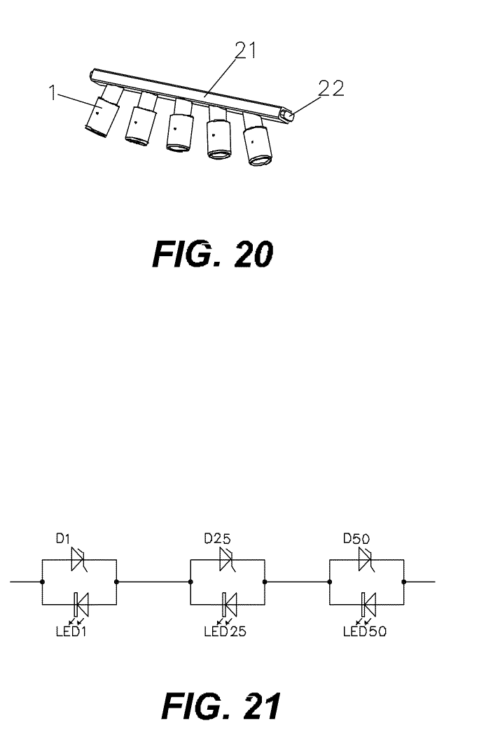

As illustrated in FIG. 18, 19, or 20, an LED lighting fixture of the present invention is comprised of an LED stand and twenty sets of cylindrical LEDs 1 mounted at different angles among one another. Each group contains five cylindrical LEDs 1. Wherein, the LED stand is assembled with twenty secondary beams 21 and two primary beams 28. Each secondary beam 21 is related to a long and narrow strip with both ends respectively provided with a protruding piece 22 for locking the secondary beam 21 to the primary beam 28. Five mounting holes to respectively secure each cylindrical LED 1 are disposed on the secondary beam 21. Each central mounting hole 24 allows a central cylindrical LED to illuminate downwardly and vertically to the ground while an inner side of each of the remaining four mounting holes is made an inclination different from one another so that those four cylindrical LEDs 1 are in sequence arranged either outwardly in radius or inwardly in convergence in symmetry to the central cylindrical LED 1. Each primary beam 28 is disposed with twenty locking holes 29 to match those protruding pieces disposed on each of both ends of the secondary beam 21. Those twenty secondary beams 21 disposed in equal number, i.e., 10, respectively on both sides of a central secondary beam 21 (not installed in this preferred embodiment) are in sequence on each side arranged either outwardly in radius or inwardly in convergence and in symmetry to the central secondary beam 21. As illustrated in the preferred embodiment, each cylindrical LED 1 is fixed to the secondary beam to prevent from adjusting its angle; and the arrangement in sequence of those LEDs on both sides either outwardly in radius or inwardly in convergence and in symmetry to the central LED is realized totally depending on the control of the inclination on the inner side of each mounting hole and on the installation angle of each locking hole.

In a seventh preferred embodiment of the present invention, each LED is an equivalent to an LED flashlight if a cylindrical LED is used. A housing of each LED is made of a metal material with good heat radiation effects; all LEDs 1 are mounted on the LED stand 2 spaced at a proper interval; and the housing of each LED 1 is fully exposed in the air; therefore, the installation of a heat radiation device may be omitted in the LED lighting fixture of the present invention thus to reduce production cost, and make the LED streetlamp smaller in volume and lighter in weight for facilitating installation and service.

A lampshade 27 made of a regular plate glass and provided with a lens is disposed in an eighth preferred embodiment of the present invention. An LED 1 lamp disposed at a certain inclination not only reflects but also refract light thus to suffer a comparatively poor light permeability; and light permeability of the LED 1 lamp gets worse as its angle and its refraction become greater.

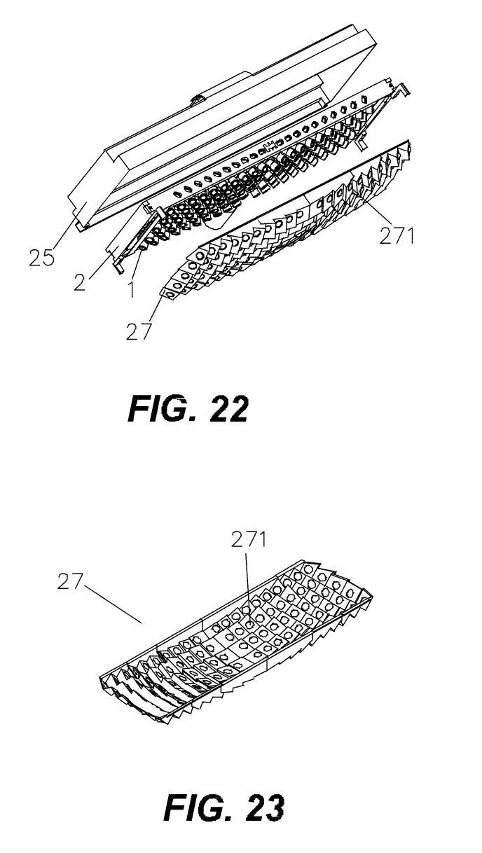

As illustrated in FIGS. 22 and 23, the present invention is comprised of a lid 25, an LED stand 2, multiple cylindrical LEDs 1 and a lampshade 27; wherein a lens 271 at a right angle to the beam of light from each LED is disposed on the lampshade 27. The lens 271 is mounted to the lampshade 271 by infusion, ultrasonic fusion or clamp dissension; or both of the lampshade 27 and the lens 271 are made in an integrated party by using an injection molding method.

The lighting fixture of the present invention retains the best light permeable effects for the lampshade since light of beam emitted by each LED 1 vertically illuminate on the lens 271 to reduce the light loss otherwise created due to refraction of light source.

The lampshade 27 may be broken down into multiple sections. As illustrated in FIG. 23, the lampshade 27 with its horizontal axis as a central line is broken down into three sections in symmetry to the central line to eliminate problems of difficulties in removing the mold and comparatively higher production cost resulted from excessively more angles of the lens 271 and excessively larger size of the lampshade 27 while allowing modularization of the product for products in different model numbers to share a common mold.

In a ninth preferred embodiment of the present invention, multiple air inlets 252 and multiple air outlets 253 are disposed to a lid 25; and two filtration hoods 251 are respectively disposed over the air inlets 252 and air outlets 253.

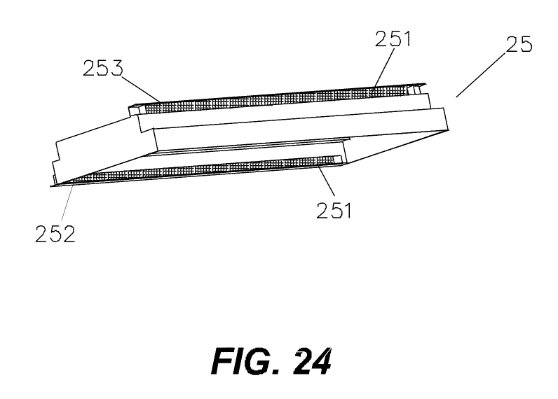

As illustrated in FIG. 24, multiple air inlets 252 are disposed on a lower end to one side of the lid 25 and multiple air outlets 253 are disposed on an upper end to the other side of the lighting fixture of the present invention; and two filtration hoods 251 are respectively disposed over the air inlets 252 and the air outlets 253. According to the principle that hot air rises, an air circulation creates in the lid 25 when the lighting fixture of the present invention operates, air passes those air inlets 252 to enter into the lid and hot air is then discharged through those air outlets 253 thus to reduce the temperature of those LEDs. Meanwhile, the filtration hood also prevents ingression of bugs and dust; and in case of a raining day, the filtration hood 251 washes away foreign matters thereon to provide voluntary cleaning function.

I claim:

1. An LED based lighting method comprising the following steps:
(1) Multiple LEDs are mounted on a lamp stand of an LED fixation plate and arranged in array;
(2) Each LED is disposed at its front with a lens device;
(3) The area to be illuminated is divided into multiple illuminated units in a number equal to that of those LEDs provided, and each LED corresponds to one illuminated unit; and
(4) A spot created by LED illumination merely covers up its corresponding illuminated unit through proper focusing of the lens device and selection of a proper LED illumination angle.

2. The LED based lighting method as claimed in claim 1, wherein the lens device is related to a convex zooming device; and the distance between the convex lens and the LED is adjusted to such that the LED is located at where between zero focal length and two time of focal length of the convex lens.

3. The LED based lighting method as claimed in claim 2, wherein the adjustment of distance between the LED and the convex lens is realized by means of a telescope structure.

4. The LED based lighting method as claimed in claim 1, wherein a lens of different focusing angle of the beam of light is selected when the focus of the lens device is not adjustable, and a spot created from illumination through the lens device merely covers up an illumination unit the lens device corresponds to.

5. The LED based lighting method as claimed in claim 4, wherein the lens is related to a total reflection, mono-convex or biconvex lens.

6. The LED based lighting method as claimed in claim 1, wherein the proper LED illumination angle is related to that those LED are arranged in array with the LED located at the center of the array illuminates downward and vertically to the ground; the remaining LEDs disposed on both sides are in sequence either outwardly arranged in radius or inwardly in convergence in symmetry and to the central LED; and the included angle defined by each LED and the central LED gradually and outwardly becomes greater; should all LEDs other than the central one be distributed in symmetry to the central LED in radius, the relation between the illumination length, X, of each LED and the included angle a is described in a formula of X=(N−M)/sin a; wherein N is the range between a center of an illuminated unit that a certain LED corresponds to and the center of the illuminated unit that the central LED corresponds to; and
M, the distance between that LED and the central LED; and the included angle a is solved by operating the formula and the illumination angle of the LED is determined accordingly.

7. The LED based lighting method as claimed in claim 1, wherein an illumination angle of the LED is fixed or adjustable.

8. A lighting fixture of an LED based lighting method comprising A lighting fixture using the LED based lighting method is comprised of a lid, multiple LEDs, and an LED stand; the LED stand is disposed in the lid and those LEDs disposed thereon are arranged in array; a lens device is disposed to a front of the LED; a central LED on the LED stand illuminates downward and vertically to the ground; LEDs on both sides are in sequence arranged either in radius outwardly or in convergence inwardly in symmetry; should all LEDs other than the central one be distributed in symmetry to the central LED in radius, the relation between the illumination length, X, of each LED and the included angle a is described in a formula of X=(N−M)/sin a; wherein N is the range between a center of an illuminated unit that a certain LED corresponds to and the center of the illuminated unit that the central LED corresponds to; and M, the distance between that LED and the central LED; and the included angle a is solved by operating the formula and the illumination angle of the LED is determined accordingly; if all the LEDs in sequence are arranged inwardly in convergence and in symmetry to the central LED; the relation between the illumination length L of each LED and the included angle a is expressed in a formula: L=(y+y1)/sin a; wherein, y is the range between a center of an illuminated unit that a certain LED corresponds to and the center of the illuminated unit that the central LED corresponds to; and y1, the distance between that LED and the central LED; and the included angle a is solved by operating the formula and the illumination angle of the LED is determined accordingly.

9. The lighting fixture of an LED based lighting method as claimed in claim 8, wherein the lens device is related to a convex zooming device and the LED is located at where between zero focal length and two time of focal length of the convex lens.

10. The lighting fixture of an LED based lighting method as claimed in claim 9, wherein the LED indicating a cylindrical shape is comprised of two tubes; the LED is disposed in a tube and the convex lens is disposed in another tube and located in front of the LED; both tubes are inserted to each other and allow travel by sliding for adjusting the distance between the LED and the convex lens for the LED to be located at where between zero focal length and two time of focal length of the convex lens.

11. The lighting fixture of an LED based lighting method as claimed in claim 8, wherein the focal length of the lens device is not adjustable, and a lens of different light beam focusing angle is selected for the illuminating spot of the LED to merely cover up its corresponding illuminated unit.

12. The lighting fixture of an LED based lighting method as claimed in claim 11, wherein the convex lens is of a total reflection, mono-convex or biconvex lens.

13. The lighting fixture of an LED based lighting method as claimed in claim 8, wherein the LED lamp stand is made in a plate or an arc form.

14. The lighting fixture of an LED based lighting method as claimed in claim 13, wherein the LED stand is comprised of multiple jigsaw pieces; each piece is disposed with multiple protruding and recessed edges to be abutted to other jigsaw pieces; each piece is disposed with at least one mounting hole to secure the LED; and the surface of each piece may be made in flat or in an arc form.

15. The lighting fixture of an LED based lighting method as claimed in claim 8, wherein the lighting fixture is comprised of an LED stand and multiple cylindrical LEDs; the LED stand is comprised of multiple secondary beams and two primary beams; each secondary beam is related to a long and narrow strip with both ends respectively disposed with a protruding piece to lock the secondary beam to the primary beam; and a mounting hole to secure the cylindrical LED in place; the mounting hole disposed on the central LED permits the central LED made in a cylindrical form to illuminate downwardly and vertically to the ground; the inner side of the mounting hole is made an inclination that is different from that of another mounting hole so that those LEDs to be arranged in sequence and in symmetry either in radius outwardly or in convergence inwardly from or to the central LED; the primary beam is disposed with locking hole to fit the protruding piece of the secondary beam; each locking hole is made an angle from that of another locking hole so that those secondary beams on both sides are arranged with a central secondary beam as a center in sequence and in symmetry either in radius outwardly or in convergence inwardly from or to the central secondary beam; and each cylindrical LED is fixed to the secondary beam.

16. The lighting fixture of an LED based lighting method as claimed in claim 10, wherein the cylindrical LED is related to an LED flash light.

17. The lighting fixture of an LED based lighting method as claimed in claim 10, wherein the cylindrical LED is fixed in place or movably mounted with its angle adjustable to the LED stand.

18. The lighting fixture of an LED based lighting method as claimed in claim 8, wherein the series circuit of the LED is related to a bypass circuit.

19. The lighting fixture of an LED based lighting method as claimed in claim 8, wherein the DC voltage on the LED is related to a pulsation with a working cycle no less than 50 Hz and its strobe is invisible to human eyes.

20. The lighting fixture of an LED based lighting method as claimed in claim 8, wherein a light permeable lampshade is disposed in front of the lid.

21. The lighting fixture of an LED based lighting method as claimed in claim 20, wherein a convex lens is disposed on the lampshade; and the convex lens is located in front of and vertically to beam of light of the LED.

22. The lighting fixture of an LED based lighting method as claimed in claim 8, wherein multiple air inlets are disposed on a lower end to one side of the lid and multiple air outlets are disposed on an upper end on an upper end to another side of the lid.

23. The lighting fixture of an LED based lighting method as claimed in claim 22, wherein two filtration hoods are respectively provided over the air inlets and the air outlets.
